(19) United States
(12) Patent Application Publication
(10) Pub. No.: US 2007/0064167 A1
(43) Pub. Date: Mar. 22, 2007

(54) Liquid crystal display and method of repairing bad pixels

(75) Inventor: Hee-joon Kim, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/471,116

(22) Filed: Jun. 19, 2006

(30) Foreign Application Priority Data
Jun. 17, 2005 (KR) 10-2005-0052511

(51) Int. Cl. G02F 1/1333

(52) U.S. Cl. 349/54

(57) ABSTRACT

A liquid crystal display which easily repairs bad pixels and a method of repairing bad pixels of the liquid crystal display are provided. The liquid crystal display includes a gate line formed on an insulating plate and extending in a first direction, a data line formed on the insulating plate and extending in a second direction that is substantially perpendicular to the first direction. The data line is electrically separated from the gate line. A pixel electrode is formed in each pixel on the gate line and the data line, a thin film transistor (TFT) is connected to the gate line, the data line, and the pixel electrodes, and a repairing interconnection overlapping the data line in at least two places. The repairing interconnection is insulated from adjacent elements.

This application claims priority from Korean Patent Application No. 10-2005-0052511 filed on Jun. 17, 2005 in the Korean Intellectual Property Office, the disclosure of which is incorporated herein by reference in its entirety.

### BACKGROUND OF THE INVENTION

1. Field of the Invention

The present invention relates generally to a display device and more particularly to a liquid crystal display (LCD) and a method of repairing bad pixels in the LCD.

2. Description of the Related Art

Cathode ray tubes (CRTs) are widely used as the display screen in televisions (TVs), monitoring systems, and information terminal devices such as computers. However, CRTs are gradually being replaced by other types of display devices because the bulkiness of a CRT makes it unsuitable for compact, light-weight electronic products.

Liquid crystal display (LCD) is one of the display devices that is replacing the CRT in many applications. LCD has advantages that make it well-suited to today's consumer electronics, such as light weight, thinness, low power consumption. LCD takes advantage of electrical and optical properties of liquid crystals injected into a liquid crystal panel to display an image. Due to the advantages mentioned above, LCD is widely used in various kinds of electronic devices including computers, mobile communication devices, and so on.

An LCD includes two substrates having a color filter and a TFT array, and a liquid crystal layer interposed between the two substrates. More specifically, there are a plurality of data lines, a plurality of gate lines that intersect the data lines, and TFTs formed near the intersections of the data lines and the gate lines in one of the two substrates. The TFTs are driven by the gate lines and the data lines.

A pixel is “bad” or defective if the data line that carries signals to the pixel is susceptible to opening only partway. With a bad pixel, when one data line is opened, all other pixels that are connected to the data line do not operate because they do not receive the data signal. This bad pixel defect negatively affects the yield. To increase the yield of LCDs, a method of easily repairing the bad pixels is desired.

### SUMMARY OF THE INVENTION

Exemplary embodiments of the present invention provide a liquid crystal display (LCD) including a component that allows easy repairing of bad pixels. Exemplary embodiments of the present invention also provide a method of repairing bad pixels in the LCD.

In one exemplary embodiment of the present invention, an LCD includes a gate line formed on an insulating plate and extending in a first direction, a data line formed on the insulating plate and extending in a second direction that is substantially perpendicular to the first direction, and a pixel electrode. The data line is electrically separated from the gate line. The pixel electrode is formed in each pixel on the gate line and the data line. A thin film transistor (TFT) is connected to the gate line, the data line, and the pixel electrode, and a repairing interconnection overlaps the data line in at least two places. The repairing interconnection is electrically isolated.

According to another exemplary embodiment of the present invention, a liquid crystal display includes a gate line formed on an insulating plate, and a data line formed on the insulating plate and extending in a second direction that is substantially perpendicular to the first direction. The data line is electrically separated from the gate line. A pixel electrode is formed in a bent shape in each pixel on the gate line and the data line. A thin film transistor (TFT) is connected to the gate line, the data line, and the pixel electrode. A repairing interconnection is aligned with an interpixel gap that overlaps the data line. The interpixel gap is located between gate lines, and the repairing interconnection is electrically insulated from adjacent elements.

In yet another exemplary embodiment of the present invention, a method of repairing bad pixels of a liquid crystal display includes preparing the liquid crystal display mentioned above, and irradiating an overlapping portion with a laser beam to bond the data line and the repairing interconnection in the two places. The overlapping region includes an overlap of the data line and the repairing interconnection.

### BRIEF DESCRIPTION OF THE DRAWINGS

The above and other features and advantages of the present invention will become more apparent by describing in detail exemplary embodiments thereof with reference to the attached drawings in which:

FIG. 1A is a plan view of a thin film transistor (TFT) substrate for a liquid crystal display (LCD) according to an exemplary embodiment of the present invention;

FIG. 1B is a plan view of a common electrode substrate for the LCD illustrated in FIG. 1A;

FIG. 1C is a plan view of the LCD including the TFT substrate and the common electrode substrate of FIG. 1A;

FIG. 2A is a cross-sectional view taken along a line IIa-IIa′ of FIG. 1A;

FIG. 2B is a cross-sectional view taken along lines IIb-IIb′ and IIb′-IIb″ of FIG. 1A;

FIG. 2C is a cross-sectional view taken along a line IIc-IIc′ of FIG. 1C;

FIG. 3 is a plan view of an LCD according to an exemplary embodiment of the present invention; and

FIG. 4 is a plan view of an LCD according to an exemplary embodiment of the present invention.

### DETAILED DESCRIPTION OF THE INVENTION

The present invention will now be described more fully with reference to the accompanying drawings showing the preferred embodiments of this invention. Advantages and features of the present invention and methods of accomplishing the same may be understood more readily by reference to the following detailed description of the embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

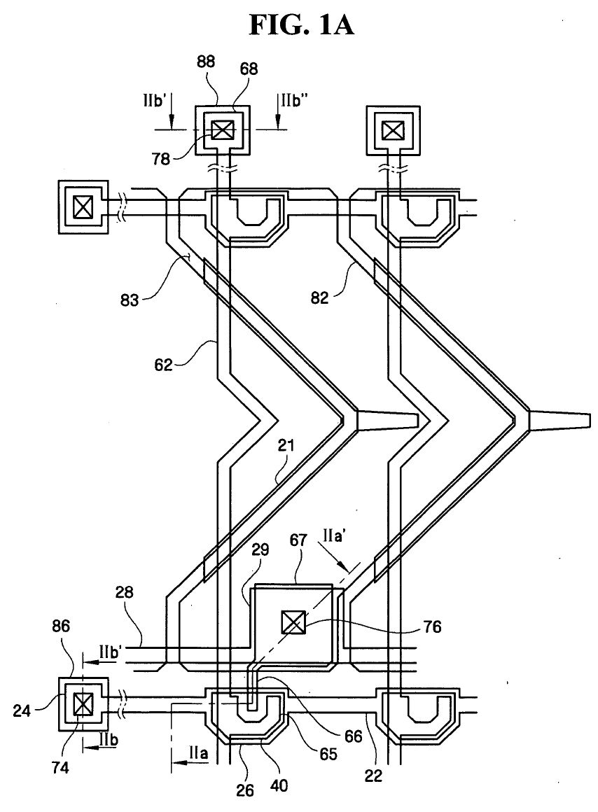

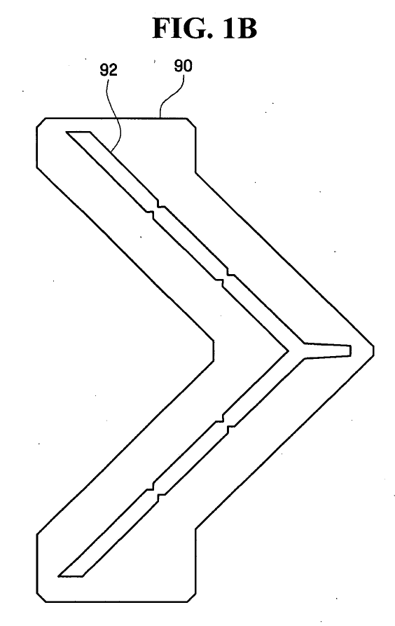

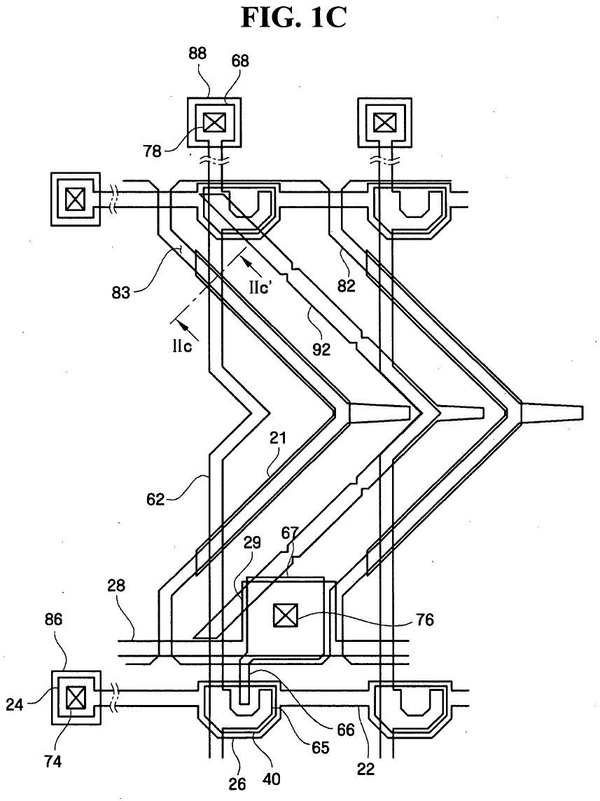

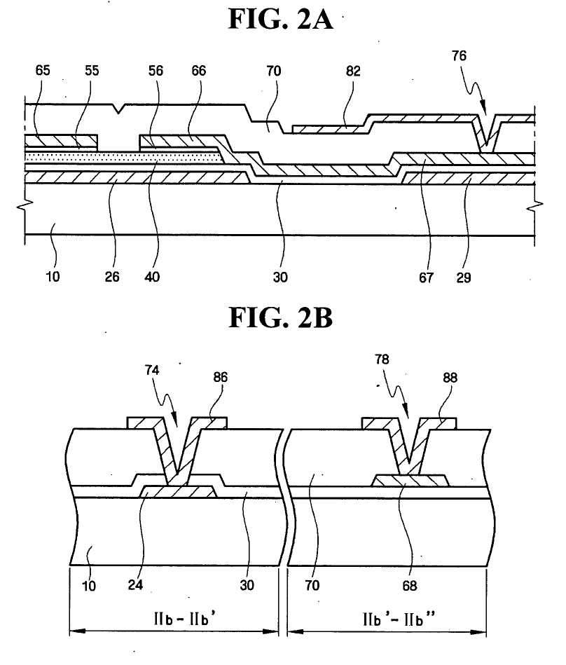

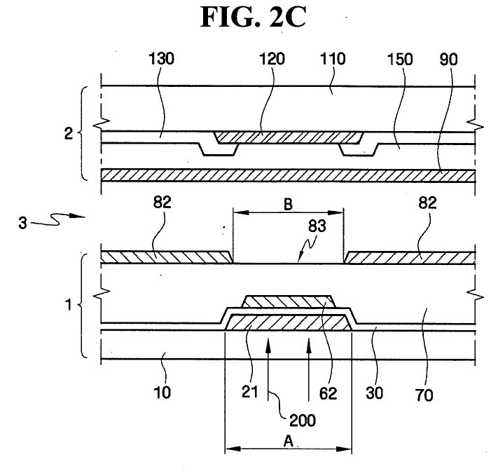

A TFT substrate for an LCD according to an exemplary embodiment of the present invention is described with reference to FIGS. 1 through 2C. FIG. 1A is a plan view of a TFT substrate for an LCD, FIG. 1B is a plan view of a common electrode substrate for the LCD illustrated in FIG. 1A, and FIG. 1C is a plan view of the LCD including the TFT substrate and the common electrode substrate of FIG. 1A. FIG. 2A is a cross-sectional view taken along a line IIa-IIa′ of FIG. 1A, FIG. 2B is a cross-sectional view taken along lines IIb-IIb′ and IIb′-IIb″ of FIG. 1A, and FIG. 2C is a cross-sectional view taken along a line IIc-IIc′ of FIG. 1C.

As shown in FIG. 2C, the LCD includes a TFT substrate 1, a common electrode substrate 2 which faces the TFT substrate 1, and a liquid crystal layer 3 formed between the substrates 1 and 2 with liquid crystals oriented in a predetermined direction.

The TFT substrate I will now be described in greater detail with reference to FIGS. 1A, 2A, 2B, and 2C.

A gate line 22 is formed on an insulating plate 10 such that it extends in a first direction (horizontal direction with respect to FIG. 1A) and ends at a gate line end 24. A gate electrode 26 in the form of a protrusion is electrically coupled to the gate line 22. The gate line end 24 transfers a gate signal from another layer or an outside element to the gate line 22. The width of the gate line end 24 extends to be connected to an external circuit. The gate line 22, the gate electrode 26, and the gate line end 24 are herein referred to as gate interconnection.

In addition, a storage electrode line 28 and a storage electrode 29 are formed on the insulating plate 10. The storage electrode line 28 extends in the first direction (horizontal direction with respect to FIG. 1A) while crossing a pixel region. The storage electrode 29 that is wider than the storage electrode line 28 is electrically coupled to the storage electrode line 28. The storage electrode line 28 and the storage electrode 29 are herein referred to as storage electrode interconnection. The shape and arrangement of the storage electrode interconnection may be changed in various ways.

A recovering interconnection 21 that is electrically insulated from the gate interconnections 22, 24, and 26 and the storage electrode interconnections 28 and 29 are formed on the insulating plate 10 along the edges of a pixel area. A pixel area is a region that has the pixel electrode 82. Although the recovering interconnection 21 will be described later, the recovering interconnection 21 is formed to correspond to an interpixel gap 83 located between adjacent pixel electrodes 82. Thus, the shape and arrangement of the recovering interconnection 21 may be changed in various ways according to the shape of the pixel electrodes 82.

The gate interconnections 22, 24, 26, the storage electrode interconnections 28 and 29, and the recovering interconnection 21 may be formed of aluminum-based metal such as aluminum (Al) and Al alloy, silver-based metal such as silver (Ag) and Ag alloy, copper-based metal such as copper (Cu) and Cu alloy, molybdenum-based alloy such as molybdenum (Mo) and Mo alloy, chrome (Cr), titanium (Ti), or tantalum (Ta). In addition, the gate interconnections 22, 24, 26, the storage electrode interconnections 28 and 29, and the recovering interconnection 21 may have a multi-layer structure including two conductive layers (not shown) having different physical properties. One of the conductive layers is formed of metal having low resistivity, for example, Al-based metal, Ag-based metal, or Cu-based metal, so as to reduce signal delay or voltage drop of the gate interconnections 22, 24, and 26 and the storage electrode interconnections 28 and 29. The other conductive layer is formed of a material having excellent contact characteristics with indium tin oxide (ITO) and indium zinc oxide (IZO), for example Mo-based metal, Cr, Ti, or Ta. Examples of good combination of the conductive layers include a combination of a Cr lower film and an Al upper film, a combination of an Al lower film and a Mo upper film, and so on. However, the present invention is not limited to conductive layers of these compositions, and the gate interconnections 22, 24, and 26, the storage electrode interconnections 28 and 29, and the recovering interconnection 21 may be formed of other suitable metal and/or conductors.

A gate insulating layer 30 is formed on the gate interconnections 22, 24, and 26, the storage electrode interconnections 28 and 29, and the recovering interconnection 21.

A semiconductor layer 40 formed of hydrogenated amorphous silicon or polycrystalline silicon is formed on the gate insulating layer 30. The semiconductor layer 40 may be formed as an island, a line, etc. In the embodiment that is shown, the semiconductor layer 40 is formed as an island on the gate electrode 26. W hen the semiconductor layer 40 is formed as an island, it is placed under a data line 62 and may extend over a portion of the gate electrode 26.

An island ohmic contact layer or a linear ohmic contact layer is formed on the semiconductor layer 40. The ohmic contact layer is formed of a material such as silicide or n⁺ hydrogenated amorphous silicon in which n-type impurities are doped at a high concentration. The ohmic contact layers 55 and 56 of the present embodiment are formed as islands and placed under a source electrode 65 and a drain electrode 66, respectively. A linear ohmic contact layer is formed to extend in a lower portion of the data line 62.

The data line 62 and the drain electrode 66 are formed on the ohmic contact layers 55 and 56 and the gate insulating layer 30. The data line 62 extends in the second direction and intersects the gate line 22. The source electrode 65 that extends over a portion of the ohmic contact layer 55 branches from the data line 62. A data line end 68 is formed at an end of the data line 62. The data line end 68 receives a data signal applied from another layer or an outside device and transmits it to the data line 62. The data line end 68 is made wider than the data line 62 to be connected to an external circuit. The drain electrode 66 is separated from the source electrode 65 and placed over the ohmic contact layer 56. As shown in FIG. 2A, the source electrode 65 and the drain electrode 66 are separated by the gate electrode 26. The data line 62, the data line end 68, and the source electrode 65 are referred to as data interconnection.

Here, the data line 62 includes an angled portion and a linear portion that may repeat periodically through the length of the data line 62. In this case, the angled portion of the data line 62 includes two straight lines, with one of the straight lines forming a 45-degree angle with respect to the gate line 22 and the other straight line forming a −45 degree with respect to the gate line 22. The source electrode 65 is connected to the linear portion of the data line 62, which intersects the gate line 22 and the storage electrode line 28.

A region in which the gate line 22 and the data line 62 intersect may have a bent shape like the pixel electrodes 82. In this way, the data line 62 may be formed of a combination of a linear portion and a V-shaped portion, like the shape of the pixel. However, the present invention is not limited to a particular shape of the data line 62, and the data line 62 may be formed as a single straight line (e.g., a line extending in the second direction or a line extending diagonally to the second direction).

In addition, the drain electrode 66 is formed to overlap the storage electrode 29 so that the drain electrode 66 and the storage electrode 29 sandwich the gate insulating layer 30 to form a storage capacitor.

The data line 62, the source electrode 65, and the drain electrode 66 may be formed of a refractory metal such as Cr, Mo-based metal, Ta, and Ti and may have a multi-layer structure. The multi-layer structure may have a lower film (not shown) made of a refractory metal and an upper film (not shown) made of a low-resistance material. For example, the multi-layer structure may be a triple layer structure of Mo film/Al film/Mo film. In some cases, the multi-layer structure has two layers: a Cr lower film and an Al upper film or an Al lower film and a Mo upper film.

At least a portion of the source electrode 65 overlaps the semiconductor layer 40, the drain electrode 66 is separated from the source electrode 65 by a gap that reveals the gate electrode 26, and at least a portion of the drain electrode 66 overlaps the semiconductor layer 40. Here, the ohmic contact layers 55 and 56 are disposed between the semiconductor layer 40 and the source electrode 65 and the drain electrode 66, respectively, to reduce contact resistance.

One end of the drain electrode 66 is a narrow bar that overlaps the semiconductor layer 40. The other end of the drain electrode 66 is a large-area drain electrode extension unit 67 that overlaps with the storage electrode 29.

A protective layer 70 containing an insulating material is disposed on the data line 62, the drain electrode 66, and the exposed semiconductor layer 40. In an exemplary embodiment, the protective layer 70 is formed of an inorganic material made of nitrification silicon or oxidation silicon, an organic material having an excellent planarization property and photosensitivity, or a low dielectric constant (low-k) insulating material formed of a-Si:C:O or a-Si:O:F. The protective layer may be deposited using plasma enhanced chemical vapor deposition (PECVD). The protective layer 70 may be a double layer of a lower inorganic film and an upper organic film so as to protect the exposed semiconductor layer 40 while keeping excellent characteristics of the organic film.

Contact holes 78 and 76 are formed in the protective layer 70. The data line end 68 and the drain electrode extension unit 67 are exposed through the contact holes 78 and 76. A contact hole 74 through which the gate line end 24 is exposed is formed in the protective layer 70 and the gate insulating layer 30. Pixel electrodes 82 are electrically connected to the drain electrode 66 through the contact hole 76 and formed in a V-shape along the edges of a pixel.

In addition, an auxiliary gate line end 86 and an auxiliary data line end 88 are formed on the protective layer 70. The auxiliary gate line end 86 and the auxiliary data line end 88 are connected to the gate line end 24 and the data line end 68, respectively. The pixel electrode 82, the auxiliary gate and data line ends 86 and 88 are formed of a transparent conductor such as ITO or IZO or a reflective conductor such as Al. The auxiliary gate and data line ends 86 and 88 electrically couple the gate line end 24 and the data line end 68 to an external device.

The pixel electrodes 82 are physically and electrically connected to the drain electrode 66 through the contact hole 76 such that data voltage is applied to the pixel electrodes 82 through the drain electrode 66.

The pixel electrodes 82 to which the data voltage is applied generate an electrical field together with the common electrode 90 of the common electrode substrate 2, thus determining the arrangement of liquid crystal molecules of the liquid crystal layer 3 between the pixel electrodes 82 and the common electrode 90.

Although not shown, the pixel electrodes 82 may be divided into a plurality of domains using a cutout (not shown) formed parallel to the data line 62. A protrusion may be formed at a position of the cutout, and the cutout or the protrusion is referred to as a domain dividing unit. Both the pixel electrodes 82 and the common electrode 90 of the common electrode substrate 2 may be divided into a plurality of domains using the domain dividing unit. The arrangement of the liquid crystal molecules of the liquid crystal layer 3 can be determined by forming a lateral field in a predetermined direction using the domain dividing unit.

An orientation layer (not shown) which can orientate the liquid crystal layer 3 can be applied to the pixel electrodes 82, the auxiliary gate line and data line ends 86 and 88, and the protective layer 70.

The common electrode substrate will now be described with reference to FIGS. 1B, 1C, and 2C.

A black matrix 120 for preventing leakage of light and a color filter 130 are formed under the insulating plate 110. The color filter 130 includes filters that produce red, green, and blue colors that are sequentially arranged in a pixel. The insulating plate 110 contains a transparent insulating material such as glass. An overcoat film 150 contains an organic material and is formed on the color filter 130 and the black matrix 120. The common electrode 90 contains a transparent insulating material such as glass and has a cutout 92 formed on the overcoat layer 150. In this case, the cutting unit 92 is formed in a V-shape similar to the shape of the pixel.

As described above, the cutout 92, which serves as the domain dividing unit, has a width of about 7 to about 14 μm. A protrusion formed of an organic material may be, used as a domain regulating unit instead of the cutout 92.

Here, the black matrix 120 includes a straight portion corresponding to the angled portion of the data line 62, a straight portion corresponding to the linear portion of the data line 62, and a rectangular portion corresponding to the TFT portion.

The color filter 130 extends in the second direction along the black matrix 120 and is periodically bent to trace the shape of the pixel. In the present embodiment, the color filter 130 is formed on the common electrode substrate 2. However, this is not a limitation of the present invention and the color filter 130 may be formed on the TFT substrate 1 in other embodiments.

The common electrode 90 faces the pixel electrodes 82 and has the cutout 92 formed at an angle of about 45 degree or −45 degree with respect to the gate line 22. The cutout 92 of the common electrode 90 is also V-shaped and divides the V-shaped pixel into two parts, (e.g., one to the right of the cutout 92 and one to the left). The protrusion may be formed at the position of the cutout 92, and the cutout 92 or the protrusion is referred to as a domain dividing unit.

An orientation film (not shown) which orientates the liquid crystal molecules 5 may be applied to the common electrode 90.

FIG. 1C is a plan view of the LCD including the TFT substrate and the common electrode substrate of FIG. 1A.

When the TFT substrate 1 and the common electrode substrate 2 are aligned and combined, the liquid crystal layer 3 is formed therebetween, and the liquid crystal layer 3 is vertically orientated, the basic structure of the LCD according to an embodiment of the present invention is formed.

A director of the liquid crystal molecules 5 included in the liquid crystal layer 3 is orientated to be perpendicular to the TFT substrate 1 and the common electrode substrate 2 when there is no electric field between the pixel electrodes 82 and the common electrode 90 and the liquid crystal molecules 5 have negative dielectric constant anisotropy. The TFT substrate 1 and the common electrode substrate 2 are aligned so that the pixel electrodes 82 precisely overlap the color filter 130. Then, the pixel is divided into a plurality of domains by the cutout 92 of the common electrode 90 and the interpixel gap 83. In this case, the pixel is divided into a right section and a left section by the cutout 92 and the interpixel gap 83. However, there are different orientations of liquid crystals in each of the right and left sections of the V-shaped portion such that the pixel is divided into four types of domains. That is, the pixel is divided into four types of domains according to the liquid crystal orientation when the main director of the liquid crystal molecules included in the liquid crystal is orientated while the electric field is being applied. This is not a limitation of the present invention, however, and the pixel may be divided into a plurality of domains by the domain dividing unit (e.g., cutout 92) formed in the common electrode 90 and the pixel electrode 82 and the interpixel gap 83.

The LCD is formed by elements such as a polarizer, a backlight, and the like on such basic structure.

In this case, one polarizer (not shown) is arranged at both sides of the basic structure, and one of the transmission axes of the polarizer may be parallel to the gate line 22 and the other transmission axis of the polarizer may be perpendicular to the gate line 22.

When an electric field is applied to the liquid crystals of an LCD having this structure, a liquid crystal in each domain is obliquely formed in a direction perpendicular to the long side of the domain. However, this direction is perpendicular to the data line 62 and thus is identical to a direction of the liquid crystal obliquely formed by a lateral field formed between the two adjacent pixel electrodes 82 in which the data line 62 is placed therebetween so that the lateral field helps liquid crystal orientation of each domain.

A variety of inversion driving methods such as dot inversion driving is applied to the pixel electrodes placed at both sides of the data line 62. In dot inversion driving, a voltage having an opposite polarity to a pixel electrode is applied to an adjacent pixel electrode. Besides dot inversion driving, column inversion driving, two-dot inversion driving, and the like are generally used in the LCD. Thus, the lateral field almost always forms and a direction thereof helps liquid crystal orientation of the domain.

In addition, since the transmission axes of the polarizer are disposed to be perpendicular to or parallel to the gate line 22, the polarizer can be fabricated with low cost and the liquid crystals in all domains are oriented at an angle of 45 degree with respect to the transmission axes of the polarizer. This way, best brightness can be obtained.

A method of repairing bad pixels of the LCD according to an embodiment of the present invention and a recovering interconnection used in the method will now be described in detail with reference to FIGS. 1C and 2C.

In general, since the data line 62 is longer than the gate line 22, the data line 62 is susceptible to being easily disconnected. When the data line 62 is disconnected and bad pixels are generated, the bad pixels can be easily repaired using the recovering interconnection 21. No separate repairing circuit outside of the LCD is needed to repair the bad pixels.

Referring to FIG. 2C, the repairing interconnection 21 is formed of the same material and on the same layer as the gate interconnections 22, 24, and 26 on the insulating plate 10. At least a portion of the repairing interconnection 21 and the data line 62 sandwich the gate insulating layer 30. As described above, the interpixel gap 83 separates adjacent pixel electrodes 82. The overlap of the repairing interconnection 21 and the data line 62 occurs below the interpixel gap 83. The region including the interpixel gap 83, the repairing interconnection 21, and the data line 62 is herein referred to as an “overlapping region.”

When a middle portion of the data line 62 is disconnected, a laser beam 200 shines onto the region where the repairing interconnection 21 and the data line 62 overlap from a lower portion of the insulating plate 10 of the TFT substrate 1. The laser beam 200 is used to melt a portion of the repairing interconnection 21, the gate insulating layer 30, and the data line 62 placed in the overlapped portion so that the repairing interconnection 21 and the data line 62 are electrically connected to each other. The repairing interconnection 21 and the data line 62 intersect at least twice, and the intersections are molten using the laser beam 200 so that the repairing interconnection 21 and the data line 62 are electrically connected to each other. Thus, the laser beam 200 is used to form a separate current path that bypasses the disconnected portion by the data line 62, and the repairing interconnection 21 is formed so that bad pixels can be easily repaired.

For example, the laser beam 200 may have a green wavelength band (about 532 nm). To melt the repairing interconnection 21 and the data line 62 insulated from each other by the gate insulating layer 30, the laser beam 200 of about 0.1-1 mJ can be applied. The diameter of a spot of the laser beam 200 may be about 1-4 μm.

Further, since there is an interpixel gap 82 is where the repairing interconnection 21 and the data line 62 intersect, there is no danger of the pixel electrode 82 being molten by the laser beam 200.

To connect the data line 62 using the repairing interconnection 21, the repairing interconnection 21 may intersect the data line 62 at least twice. In addition, to prevent the pixel electrodes 82 from being damaged by the laser beam 200, the repairing interconnection 21 is formed to pass the portion in which the interpixel gap 83 and the data line 62 intersect. The repairing interconnection 21 may be formed along the interpixel gap 83 so that the repairing interconnection 21 overlaps the portion in which the interpixel gap 83 and the data line 62 intersect. A width A of the repairing interconnection 21 may satisfy the relationship B≦A≦1.5B with respect to a width B of the interpixel gap 83. If the width A of the repairing interconnection 21 is smaller than the width B of the interpixel gap 83, a process margin required for melting the repairing interconnection 21 and the data line 62 is reduced. If the width A of the repairing interconnection 21 is larger than 1.5 times the width B of the interpixel gap 83, an aperture ratio of the LCD is reduced.

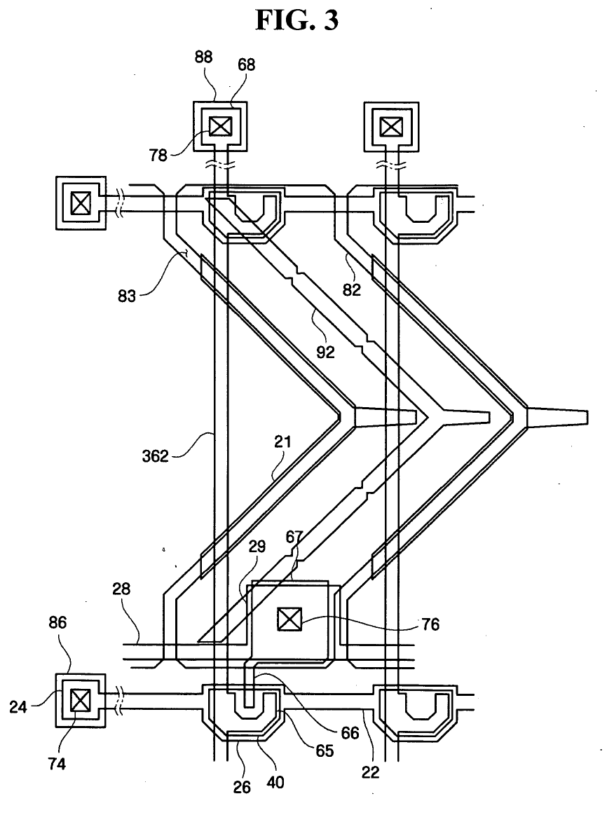

The LCD according to a second embodiment of the present invention will now be described with reference to FIG. 3. FIG. 3 is a plan view of an LCD according to an embodiment of the present invention. For brevity of explanation, elements which are the same as or similar to elements in the first embodiment will be identified using the same reference numerals, and a detailed explanation thereof will not be given. As shown in FIG. 3, the LCD of the present embodiment basically has the same structure as the LCD shown in FIGS. 1A through 1C, except for the followings. That is, referring to FIG. 3, a data line 362 includes only a vertically-elongated portion without the angled portion of the first embodiment. In this way, since the length of an interconnection of data line 362 is reduced compared to the data line 62 shown in FIGS. 1A through 1C, resistance and load of the interconnection are reduced and signal distortion is reduced. In addition, the formation of a vertical stripe caused by coupling between the data line 362 and the pixel electrodes 82 can be prevented.

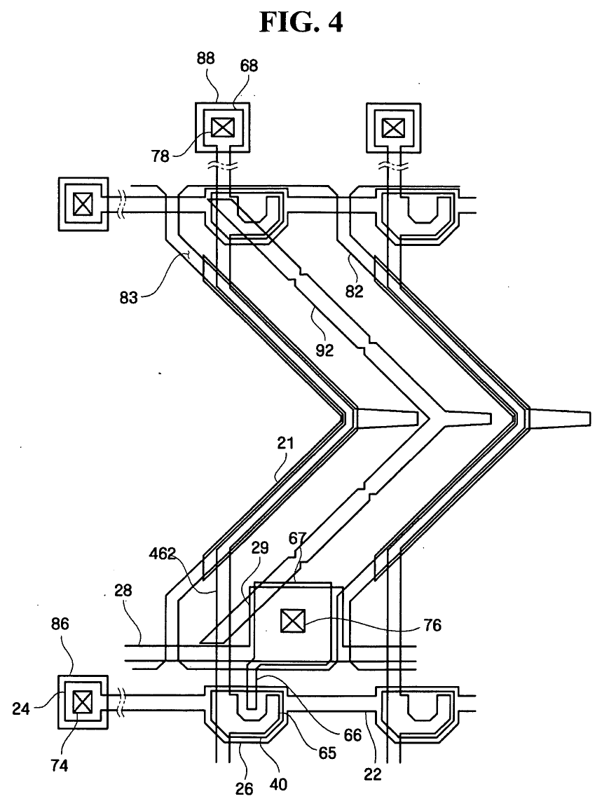

The LCD according to a third embodiment of the present invention will now be described with reference to FIG. 4. FIG. 4 is a plan view of an LCD according to an embodiment of the present invention. To avoid redundancy, elements which are the same as or similar to elements in the first embodiment will be identified using the same reference numerals, and a detailed explanation thereof will not be given. The LCD of the present embodiment basically has the same structure as the LCD shown in FIGS. 1A through 1C, except for the followings. Referring to FIG. 4, a data line 462 includes an angled portion and a linear portion. The angled portion of the data line 462 is formed along the interpixel gaps 83. In addition, the repairing interconnection 21 is formed along the interpixel gaps 83 so as to increase the area where the data line 462 and the repairing interconnection 21 overlap. In doing so, the process margin required for melting this overlapping portion using a laser beam is also increased. Since the data line 462 is bent, the overall length of the interconnection may increase compared to, for example, the embodiment of FIG. 3. However, in an ultra-high aperture ratio structure, the data line 462 is sufficiently wide and a thick organic material protective layer 70 is used so that the interconnection is small load. Thus, any signal distortion caused by an increase in the length of the data line 462 can be ignored.

As described above, the present invention allows the bad pixels to be repaired without forming a separate repairing circuit outside of the LCD.

While the present invention has been particularly shown and described with reference to exemplary embodiments thereof, it will be understood by those skilled in the art that various changes in form and details may be made therein without departing from the spirit and scope of the invention as defined by the following claims and equivalents thereof.

What is claimed is:

1. A liquid crystal display comprising:
a gate line formed on an insulating plate and extending in a first direction;
a data line formed on the insulating plate, the data line extending in a second direction and being electrically separated from the gate line;
a pixel electrode formed in each pixel on the gate line and the data line;
a thin film transistor (TFT) connected to the gate line, the data line, and the pixel electrode; and
a repairing interconnection overlapping the data line in at least two places, the repairing interconnection being electrically isolated.

2. The liquid crystal display of claim 1, wherein there are multiple pixel electrodes including the pixel electrode, wherein the pixel electrodes are separated from each other by an interpixel gap in each pixel, and wherein the interpixel gap is placed over an overlapping portion where the data line and the repairing interconnection overlap.

3. The liquid crystal display of claim 1, wherein the repairing interconnection is formed of the same material and layer as the gate line.

4. The liquid crystal display of claim 1, wherein the repairing interconnection is formed along the interpixel gap.

5. The liquid crystal display of claim 1, wherein a width A of the repairing interconnection satisfies the relationship B≦A≦1.5B with respect to a width B of the interpixel gap.

6. A liquid crystal display comprising:
a gate line formed on an insulating plate;
a data line formed on the insulating plate, the data line extending in a second direction and being electrically separated from the gate line;
a pixel electrode formed in a bent shape in each pixel on the gate line and the data line;
a thin film transistor (TFT) connected to the gate line, the data line, and the pixel electrode; and
a repairing interconnection aligned with an interpixel gap that overlaps the data line, the interpixel gap being located between gate lines, the repairing interconnection being electrically insulated from adjacent elements.

7. The liquid crystal display of claim 6, wherein the repairing interconnection is formed of the same material and layer as the gate line.

8. The liquid crystal display of claim 6, wherein the repairing interconnection is formed along the interpixel gap.

9. The liquid crystal display of claim 6, wherein a width A of the repairing interconnection satisfies the relationship B≦A≦1.5B with respect to a width B of the interpixel gap.

10. The liquid crystal display of claim 6, wherein the data line includes a linear portion extending in the second direction.

11. The liquid crystal display of claim 6, wherein the data line includes an angled portion and a linear portion, the linear portion extending in the second direction.

12. The liquid crystal display of claim 11, wherein the angled portion of the data line includes two straight lines, one of the straight lines formed at a 45-degree angle with respect to the gate line and the other of the straight lines formed at a −45-degree angle with respect to the gate line.

13. A method of repairing bad pixels of a liquid crystal display, the method comprising:
preparing the liquid crystal display including:
a gate line formed on an insulating plate and extending in a first direction;
a data line formed on the insulating plate, the data line extending in a second direction and being electrically separated from the gate line;
a pixel electrode formed in each pixel on the gate line and the data line;
a thin film transistor (TFT) connected to the gate line, the data line, and the pixel electrode; and
a repairing interconnection overlapping the data line in at least two places, the repairing interconnection being electrically isolated; and
irradiating an overlapping region with a laser beam to bond the data line and the repairing interconnection in the two places, the overlapping region including an overlap of the data line and the repairing interconnection.

14. The method of claim 13, wherein the laser beam has a green wavelength band.

15. The method of claim 14, wherein the laser beam has a wavelength of about 532 nm.

16. The method of claim 13, wherein the laser beam has an energy of about 0.1-1 mJ.

17. The method of claim 13, wherein a spot of the laser beam has a diameter of about 1-4 μm.

18. The method of claim 13, wherein the bonding of the data line and the repairing interconnection comprises melting the data line and the repairing interconnection after the laser beam passes through the insulating plate.
